(19) United States
(12) Patent Application Publication
(10) Pub. No.: US 2010/0270852 A1
(43) Pub. Date: Oct. 28, 2010

(54) Wheel Rim

(75) Inventor: Chao-Ying Chen, Shan-Shang Hsiang (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Alex Global Technology, Inc., Shan-Shang Hsiang (TW)

(21) Appl. No.: 12/429,906

(22) Filed: Apr. 24, 2009

(51) Int. Cl. B60B 21/02

(52) U.S. Cl. 301/33; 301/95.104

(57) ABSTRACT

A wheel rim includes an annular rim body having a horizontally disposed rim axis. The rim body includes an annular base wall and opposite annular side walls extending from the annular base wall. Each annular side wall includes a reinforcing segment connected to the annular base wall, and a tire coupling segment extending from the reinforcing segment. The tire coupling segments of the annular side walls cooperatively define a tire retaining space. Each reinforcing segment has an inner wall portion, an outer wall portion disposed at a radially outer side of the inner wall portion and cooperating with the inner wall portion to define an annular chamber, and at least one connecting wall portion disposed in the annular chamber, and cooperating with the inner and outer wall portions to form at least one H-shaped wall structure and to configure the annular chamber into at least two annular holes.

### BACKGROUND OF THE INVENTION

1. Field of the Invention

The invention relates to a wheel rim, more particularly to a wheel rim adapted for use in bicycles.

2. Description of the Related Art

As shown in FIGS. 1 and 2, a conventional wheel rim 1 is adapted for use in a bicycle, and is adapted for retaining a tire 22 and a plurality of spoke fixing components 21 (only one is shown in FIG. 1). The conventional wheel rim 1 includes an annular base wall 11 that has a plurality of angularly spaced-apart spoke retaining holes 111 (only one is shown), and a pair of annular side walls 12 that are connected respectively to opposite lateral edges of the annular base wall 11, and that cooperate with the annular base wall 11 to define an annular space 13. The annular space 13 has a first space portion 131 disposed adjacent to the annular base wall 11, and a second space portion 132 disposed distal from the annular base wall 11 and adapted for retaining tire beads of the tire 22. Each of the annular side walls 12 has a connecting segment 121 connected to the annular base wall 11, a tire coupling segment 122 spaced apart from the connecting segment 121 and having an inner surface that confronts the second space portion 132 of the annular space 13, and an enlarged segment 123 interconnecting the connecting segment 121 and the tire coupling segment 122 and formed with an annular hole 124. The conventional wheel rim 1 further includes a pair of connecting rods 10 inserted respectively in the annular holes 124 for interconnecting adjacent ends of the rim body, thereby retaining an annular shape of the rim body.

In use, when the tire 22 contacts the ground, the tire coupling segment 122 of each of the annular side walls 12 is subjected to a lateral force (F1), and the other portions of the rim body are applied with stresses (as indicated by the arrows in FIG. 2). However, since the structural strength of the rim body is relatively low, the lateral forces (F1) and the stresses may cause the rim body to expand, thereby adversely affecting the firmness of connection between the rim body and the tire 22. In addition, another stress (F2) (as indicated by the cross in FIG. 2) is applied to the rim body in a direction transverse to the lateral forces (F1) due to friction between the tire 22 and the ground. Since the bicycle tilts when making turns, magnitudes and directions of the forces and stresses applied to the tire 22 may change as the bicycle tilts. Therefore, during movement of the bicycle, torques on the rim body can be summed up into an equivalent total torque (T). Furthermore, during a wheel braking action, each of the annular side walls 12 is further subjected to a friction force due to friction between a brake pad (not shown) and the one of the annular side walls 12. The total torque (T) and the friction force may cause the annular side walls 12 to fracture, thereby resulting in a relatively short service life of the conventional wheel rim 1.

Although the structural strength of the abovementioned conventional wheel rim 1 can be strengthened by including an annular connecting wall that surrounds the annular base wall 11 and that interconnects the annular side walls 12 so as to provide pulling forces to the annular side walls 12 against the lateral forces (F1), such improvement is unable to provide sufficient structural strength against the total torque (T). Moreover, the inclusion of the annular connecting wall results in a relatively complicated wheel rim structure and a relatively high manufacturing cost.

### SUMMARY OF THE INVENTION

Therefore, the object of the present invention is to provide a wheel rim having a higher structural strength.

Accordingly, a wheel rim of the present invention is adapted for retaining a tire that includes a pair of tire beads. The wheel rim comprises an annular rim body having a horizontally disposed rim axis. The rim body includes an annular base wall surrounding the rim axis and having opposite lateral edges, and a pair of annular side walls extending in radial outward directions respectively from the lateral edges of the annular base wall. Each of the annular side walls includes a hollow reinforcing segment that has a connecting edge connected to a respective one of the lateral edges of the annular base wall, and a distal edge radially spaced apart from the connecting edge, and a tire coupling segment that extends radially and outwardly from the distal edge of the reinforcing segment. The annular base wall and the reinforcing segments of the annular side walls cooperatively define an internal space. The tire coupling segments of the annular side walls cooperatively define a tire retaining space adapted for retaining the tire beads of the tire. The reinforcing segment of each of the annular side walls has an inner wall portion that confronts the internal space, an outer wall portion that is disposed at a radially outer side of the inner wall portion and that cooperates with the inner wall portion to define an annular chamber, and at least one connecting wall portion that is disposed in the annular chamber, that interconnects the inner and outer wall portions, and that cooperates with the inner and outer wall portions to form at least one H-shaped wall structure and to configure the annular chamber into at least two annular holes.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of a conventional wheel rim;

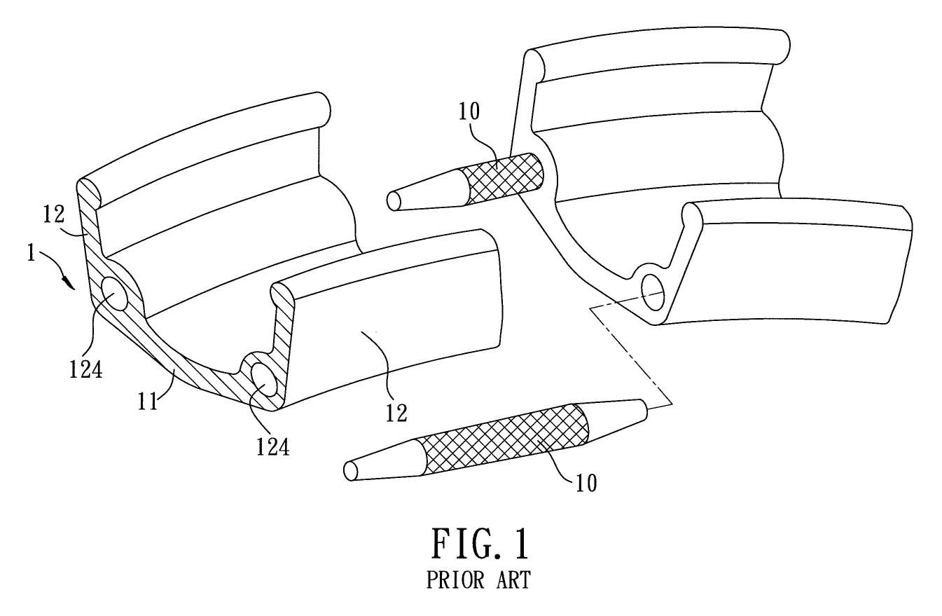

FIG. 2 is a fragmentary sectional view of the conventional wheel rim;

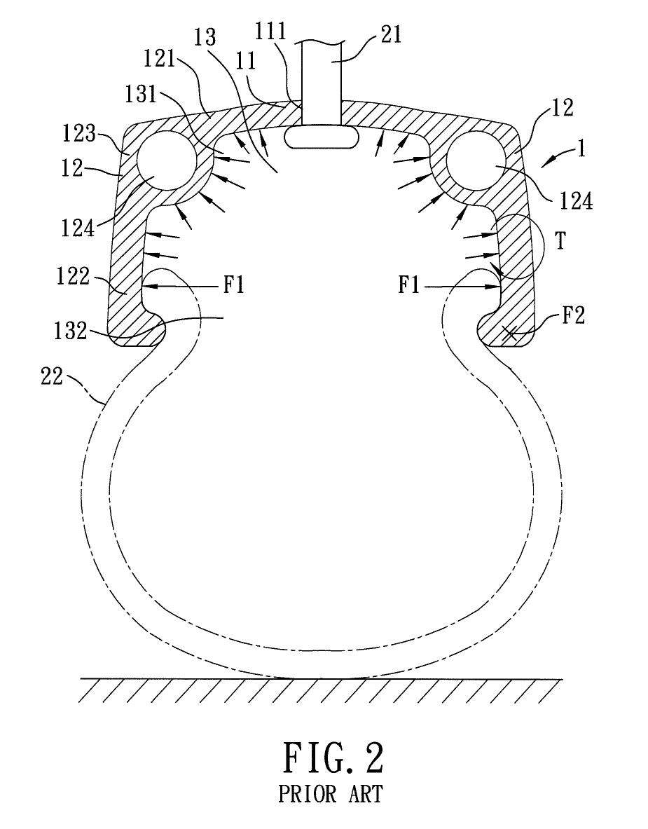

FIG. 3 is a fragmentary sectional view of a first preferred embodiment of a wheel rim according to the invention;

FIG. 4 is a perspective partly cutaway view of the first preferred embodiment; and

FIG. 5 is a fragmentary sectional view of a second preferred embodiment of the wheel rim according to the invention.

### DETAILED DESCRIPTION OF THE PREFERRED EMBODIMENTS

Before the present invention is described in greater detail, it should be noted that like elements are denoted by the same reference numerals throughout the disclosure.

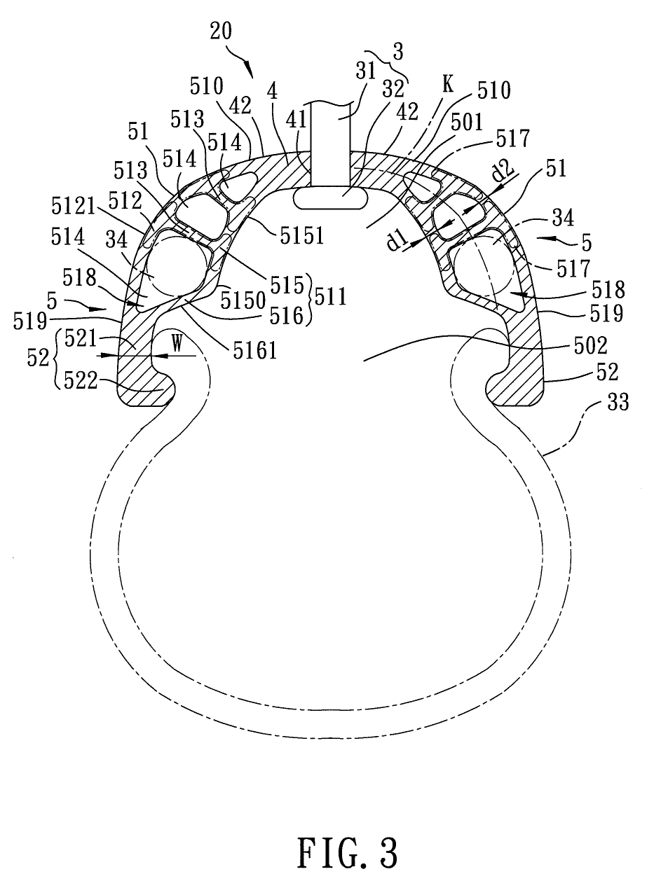

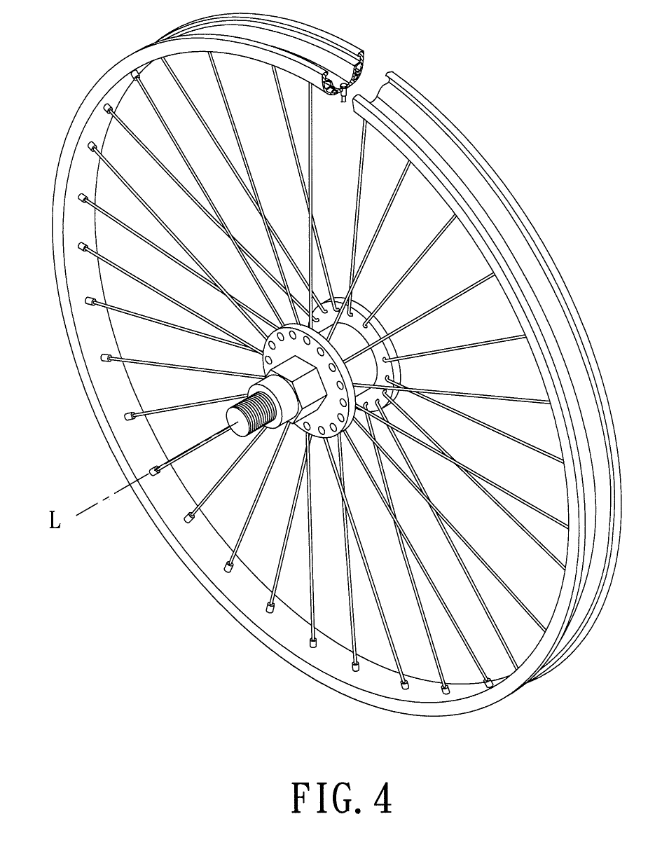

As shown in FIG. 3, the first preferred embodiment of a wheel rim according to the present invention is adapted for retaining a tire 33, and is adapted to be coupled to a plurality of spokes 3 (only one is shown in FIG. 3). The tire 33 includes a pair of tire beads. Each of the spokes 3 includes a spoke body 31 and a rim engaging portion 32 fastened to the spoke body 31. The wheel rim comprises an annular rim body 20 having a horizontally disposed rim axis (L) (see FIG. 4), and a pair of connecting rods 34. The rim body 20 includes an annular base wall 4 and a pair of annular side walls 5.

The annular base wall 4 surrounds the rim axis (L) and has opposite lateral edges 42. In this embodiment, the annular base wall 4 further has a plurality of angularly spaced-apart spoke engaging holes 41 (only one is shown) adapted to be engaged with the rim engaging portions 32 of the spokes 3, respectively.

The annular side walls 5 extend in radial outward directions respectively from the lateral edges 42 of the annular base wall 4. Each of the annular side walls 5 includes a hollow reinforcing segment 51 that has a connecting edge 510 connected to a respective one of the lateral edges 42 of the annular base wall 4, and a distal edge 519 radially spaced apart from the connecting edge 510. Each of the annular side walls 5 further includes a tire coupling segment 52 extending radially and outwardly from the distal edge 519 of the reinforcing segment 51. The annular base wall 4 and the reinforcing segments 51 of the annular side walls 5 cooperatively define an internal space 501. The tire coupling segments 52 of the annular side walls 5 cooperatively define a tire retaining space 502 adapted for retaining the tire beads of the tire 33. In this embodiment, the reinforcing segment 51 of each of the annular side walls 5 has an inner wall portion 511 that confronts the internal space 501 and that has a thickness (d1), an outer wall portion 512 that is disposed at a radially outer side of the inner wall portion 511, that has a thickness (d2), and that cooperates with the inner wall portion 511 to define an annular chamber 518, and a pair of spaced-apart connecting wall portions 513 that are disposed in the annular chamber 518, that interconnect the inner and outer wall portions 511, 512, and that cooperate with the inner and outer wall portions 511, 512 to form a pair of H-shaped wall structures 517 and to configure the annular chamber 518 into three annular holes 514. Each of the annular holes 514 has a polygonal shape. The inner wall portion 511 of the reinforcing segment 51 of each of the annular side walls 5 has a connecting part 515 connected to the respective one of the lateral edges 42 of the annular base wall 4 and having a radial outer edge 5150 opposite to the annular base wall 4 and an inner surface 5151 confronting the internal space 501, and an oblique part 516 extending obliquely from the radial outer edge 5150 of the connecting part 515 to the outer wall portion 512 and having an inner surface 5161 confronting the internal space 501. The outer wall portion 512 of the reinforcing segment 51 of each of the annular side walls 5 further has an outer surface 5121 facing away from the annular chamber 518. In this embodiment, a distance between the inner surface 5151 of the connecting part 515 of the inner wall portion 511 and the outer surface 5121 of the outer wall portion 512 of a same one of the reinforcing segments 51 gradually increases in a direction away from the annular base wall 4, and a distance between the inner surface 5161 of the oblique part 516 of the inner wall portion 511 and the outer surface 5161 of the outer wall portion 512 of a same one of the reinforcing segments 51 gradually increases in a direction toward the annular base wall 4, such that sizes of the annular holes 514 in a same one of the reinforcing segments 51 decrease from the farthest one to the nearest one of the annular holes 514 relative to the annular base wall 4, i.e., the farthest one of the annular holes 514 relative to the annular base wall 4 has the largest cross-section. Each of the connecting rods 34 is inserted in the largest one of the annular holes 514 in the reinforcing segment 51 of a respective one of the annular side walls 5 for retaining an annular shape of the rim body 20. For each of the annular side walls 5, the H-shaped wall structures 517 of the reinforcing segment 51 are connected integrally to each other along an imaginary central line (K) that extends through the annular holes 514, and cross-sections of the H-shaped wall structures 517 decrease in a direction from the distal edge 519 to the connecting edge 510 of the reinforcing segment 51. For each of the annular side walls 5, each of the connecting wall portions 513 of the reinforcing segment 51 is generally perpendicular to the inner wall portion 511.

The tire coupling segment 52 of each of the annular side walls 5 has an abutment portion 521 connected to the distal edge 519 of the reinforcing segment 51 and having a thickness (W), and a tire bead coupling portion 522 projecting from the abutment portion 521 toward the tire coupling segment 52 of the other one of the annular side walls 5. In this embodiment, for each of the annular side walls 5, the sum of the thicknesses (d1, d2) of the inner and outer wall portions 511, 512 of the reinforcing segment 51 is generally equal to the thickness (W) of the abutment portion 521 of the tire coupling segment 52.

In use, the H-shaped wall structures 517 of the reinforcing segments 51 of the annular side walls 5 are capable of providing sufficient structural strength against the total torques applied on the annular side walls 5. Moreover, for each reinforcing segment 51, since the distance between the inner surface 5151 of the connecting part 515 of the inner wall portion 511 and the outer surface 5121 of the outer wall portion 512 gradually increases in a direction away from the annular base wall 4, and since the distance between the inner surface 5161 of the oblique part 516 of the inner wall portion 511 and the outer surface 5161 of the outer wall portion 512 gradually increases in a direction toward the annular base wall 4, stresses applied to the reinforcing segment 51 can be dispersed rather than being concentrated at the connecting edge 510 of the reinforcing segment 51, thereby effectively preventing fracture of the respective annular side wall 5. Furthermore, for each of the annular side walls 5, since the sum of the thicknesses (d1, d2) of the inner and outer wall portions 511, 512 of the reinforcing segment 51 is generally equal to the thickness (W) of the abutment portion 521 of the tire coupling segment 52, the strength-enhanced annular side walls 5 can be made without necessitating extra material for the rim body 20 which leads to a heavier weight.

It should be noted that, while the reinforcing segment 51 of each of the annular side walls 5 is exemplified to include two connecting wall portions 513, only one connecting wall portion 513 may be employed in other embodiments of this invention.

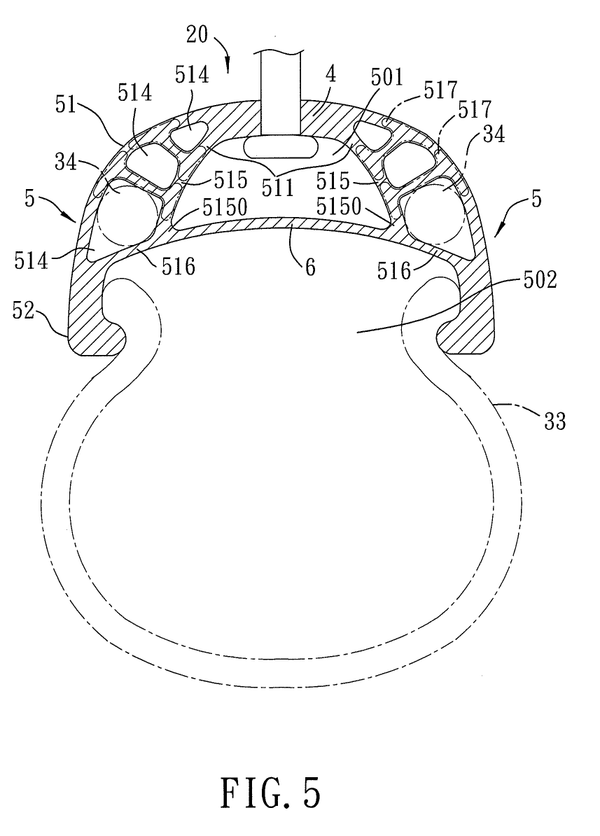

As shown in FIG. 5, the second preferred embodiment of the wheel rim according to the present invention has a structure similar to that of the first embodiment. The main difference between this embodiment and the previous embodiment resides in the following. In this embodiment, the rim body 20 further includes an annular connecting wall 6 surrounding the annular base wall 4, and interconnecting the radial outer edges 5150 of the connecting parts 515 of the inner wall portions 511 of the reinforcing segments 51 of the annular side walls 5. The annular connecting wall 6 cooperates with the oblique parts 516 of the inner wall portions 511 of the reinforcing segments 51 to form an integral wall structure having a uniform curvature. In addition, the annular connecting wall 6 separates the internal space 501 from the tire retaining space 502. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A wheel rim adapted for retaining a tire that includes a pair of tire beads, said wheel rim comprising an annular rim body having a horizontally disposed rim axis, said rim body including:
an annular base wall surrounding the rim axis and having opposite lateral edges; and
a pair of annular side walls extending in radial outward directions respectively from said lateral edges of said annular base wall, each of said annular side walls including a hollow reinforcing segment that has a connecting edge connected to a respective one of said lateral edges of said annular base wall, and a distal edge radially spaced apart from said connecting edge, and a tire coupling segment that extends radially and outwardly from said distal edge of said reinforcing segment;
wherein said annular base wall and said reinforcing segments of said annular side walls cooperatively define an internal space;
wherein said tire coupling segments of said annular side walls cooperatively define a tire retaining space adapted for retaining the tire beads of the tire; and
wherein said reinforcing segment of each of said annular side walls has an inner wall portion that confronts said internal space, an outer wall portion that is disposed at a radially outer side of said inner wall portion and that cooperates with said inner wall portion to define an annular chamber, and at least one connecting wall portion that is disposed in said annular chamber, that interconnects said inner and outer wall portions, and that cooperates with said inner and outer wall portions to format least one H-shaped wall structure and to configure said annular chamber into at least two annular holes.

2. The wheel rim as claimed in claim 1, wherein each of said annular holes in said reinforcing segments of said annular side walls has a polygonal shape.

3. The wheel rim as claimed in claim 1, wherein said tire coupling segment of each of said annular side walls has an abutment portion connected to said distal edge of said reinforcing segment, and a tire bead coupling portion projecting from said abutment portion toward said tire coupling segment of the other one of said annular side walls.

4. The wheel rim as claimed in claim 1, wherein said inner wall portion of said reinforcing segment of each of said annular side walls has a connecting part connected to the respective one of said lateral edges of said annular base wall and having a radial outer edge opposite to said annular base wall, and an oblique part extending obliquely from said radial outer edge of said connecting part to said outer wall portion.

5. The wheel rim as claimed in claim 4, wherein:
each of said connecting part and said oblique part of said inner wall portion of said reinforcing segment of each of said annular side walls has an inner surface that confronts said internal space;
said outer wall portion of said reinforcing segment of each of said annular side walls has an outer surface that faces away from said annular chamber;
a distance between said inner surface of said connecting part and said outer surface of said outer wall portion of a same one of said reinforcing segments gradually increases in a direction away from said annular base wall; and
a distance between said inner surface of said oblique part and said outer surface of said outer wall portion of a same one of said reinforcing segments gradually increases in a direction toward said annular base wall.

6. The wheel rim as claimed in claim 1, wherein said at least one connecting wall portion of said reinforcing segment of each of said annular side walls is generally perpendicular to said inner wall portion.

7. The wheel rim as claimed in claim 1, wherein said reinforcing segment of each of said annular side walls has a spaced apart pair of said connecting walls that interconnect said inner and outer wall portions, and that cooperate with said inner and outer wall portions to form a pair of said H-shaped wall structures and to configure said annular chamber into three of said annular holes.

8. The wheel rim as claimed in claim 7, wherein cross-sections of said H-shaped wall structures of said reinforcing segment of each of said annular side walls decrease in a direction from said distal edge to said connecting edge of said reinforcing segment.

9. The wheel rim as claimed in claim 8, further comprising a pair of connecting rods, each of which is inserted in a largest one of said annular holes in said reinforcing segment of a respective one of said annular side walls of said rim body for retaining an annular shape of said rim body.

10. The wheel rim as claimed in claim 1, wherein a cross-section of said at least one H-shaped wall structure of said reinforcing segment of each of said annular side walls decreases in a direction from said distal edge to said connecting edge of said reinforcing segment.

11. The wheel rim as claimed in claim 10, further comprising a pair of connecting rods, each of which is inserted in a larger one of said annular holes in said reinforcing segment of a respective one of said annular side walls of said rim body for retaining an annular shape of said rim body.

12. The wheel rim as claimed in claim 1, wherein said rim body further includes an annular connecting wall surrounding said annular base wall, interconnecting said annular side walls, and separating said internal space from said tire retaining space.

13. The wheel rim as claimed in claim 2, wherein said rim body further includes an annular connecting wall surrounding said annular base wall, interconnecting said annular side walls, and separating said internal space from said tire retaining space.

14. The wheel rim as claimed in claim 3, wherein said rim body further includes an annular connecting wall surrounding said annular base wall, interconnecting said annular side walls, and separating said internal space from said tire retaining space.

15. The wheel rim as claimed in claim 4, wherein said rim body further includes an annular connecting wall surrounding said annular base wall, interconnecting said annular side walls, and separating said internal space from said tire retaining space.

16. The wheel rim as claimed in claim 3, wherein the sum of thicknesses of said inner and outer wall portions of said reinforcing segment of each of said annular side walls is generally equal to thickness of said abutment portion of said tire coupling segment of a same one of said annular side walls.
